(19) United States
(12) Patent Application Publication
(10) Pub. No.: US 2015/0127361 A1
(43) Pub. Date: May 7, 2015

(54) APPARATUS AND METHOD FOR AUTOMATIC TRANSLATION

(71) Applicant: ELECTRONICS AND TELECOMMUNICATIONS RESEARCH INSTITUTE, Daejeon-city (KR)

(72) Inventors: Jong-Hun SHIN, Daejeon (KR); Chang-Hyun KIM, Daejeon (KR); Oh-Woog KWON, Daejeon (KR); Ki-Young LEE, Daejeon (KR); Young-Ae SEO, Daejeon (KR); Sung-Kwon CHOI, Daejeon (KR); Yun JIN, Daejeon (KR); Eun-Jin PARK, Daejeon (KR); Jin-Xia HUANG, Daejeon (KR); Seung-Hoon NA, Daejeon (KR); Yoon-Hyung ROH, Daejeon (KR); Sang-Keun JUNG, Daejeon (KR); Young-Kil KIM, Daejeon (KR); Sang-Kyu PARK, Daejeon (KR)

(73) Assignee: ELECTRONICS AND TELECOMMUNICATIONS RESEARCH INSTITUTE, Daejeon-city (KR)

(21) Appl. No.: 14/504,497

(22) Filed: Oct. 2, 2014

(30) Foreign Application Priority Data
Nov. 5, 2013 (KR) 10-2013-0133556

(51) Int. Cl. G06F 17/28

(52) U.S. Cl. CPC G06F 17/289
USPC 705/2

(57) ABSTRACT

Disclosed are an automatic translation apparatus and method capable of optimizing limited translation knowledge in a database mounted in a portable mobile communication terminal, obtaining translation knowledge from external servers in order to provide translation knowledge appropriate for respective users, and effectively updating the database mounted in the terminal. The automatic translation apparatus includes: an input unit configured to receive translation target information inputted to be translated from a user; a translation unit configured to perform translation for the translation target information based on translation data included in a translation database and to extract translation information generated during the translation process; and a communication unit configured to transmit the translation information to a first server and to receive, from the first server, new translation data being not included in the translation database among various kinds of data necessary for performing the translation for the translation target information.

### CROSS REFERENCE TO RELATED APPLICATION(S)

This application claims the benefit of Korean Patent Application No. 10-2013-0133556, filed Nov. 5, 2013, which is hereby incorporated by reference in its entirety into this application.

### BACKGROUND OF THE INVENTION

1. Technical Field

The present invention relates generally to an apparatus and method for automatic translation and, more particularly, to an apparatus and method for automatic translation, which is configured such that limited translation knowledge data in a database mounted in a portable mobile communication terminal can be optimized, translation knowledge data can be obtained from external servers in order to provide translation knowledge data appropriate for respective users, and the database mounted in the terminal can be effectively updated.

2. Description of the Related Art

As well known to those skilled in the art, conventional arts related to the present invention are based on a mobile communication terminal which can be carried and used by users and an automatic interpretation and translation system for translating a source language inputted by a user into a target language.

The user performs automatic interpretation and automatic translation by utilizing the system and there are two methods which have been commonly used as general methods therefor.

First, there is a translation method which enables a user to obtain a desired result by utilizing a communication function of a mobile communication terminal; transmitting a source language inputted by the user to a server of a remote place; translating, by the server, the corresponding inputted source language into a target language; and thereafter returning the translation to the user.

Second, there is a translation method which is performed in such a manner as to save translation knowledge data in a mobile communication terminal, carry out translation of a source language into a target language based on the translation knowledge data possessed by the corresponding terminal, and return the translation to the user.

The present invention is intended to compensate for a problem of the second method of the two methods, namely, the translation method of saving translation knowledge data in the mobile communication terminal and performing translation into a target language via the terminal without any separate communication.

In the corresponding method, when automatic interpretation and automatic translation are performed, separate communication is not needed. Due to this, in a condition in which communication is cut off or a condition in which communication costs are expensive, the method can be usefully used.

According to the conventional art, with regard to automatic translation and automatic interpretation knowledge data mounted in a corresponding device, a restriction in the size of a storage space is generated due to a limitation of the storage space possessed by a mobile communication terminal, and accordingly, by sorting frequently requested/referred knowledge data, the knowledge data is configured to be fitted into a predetermined size. At this time, according to the conventional art, the automatic interpretation and translation knowledge data to be mounted is sorted by utilizing language knowledge data of a possessed corpus (an actual language or a sample of the actual language) and the like.

However, due to a limitation of the possessed language knowledge data, the conventional art is problematic in that a case in which actually frequently used knowledge data is not sufficiently reflected is generated, so that it is difficult for a user to obtain a desired target language result or the user obtains a wrong target language result.

Accordingly, an automatic translation apparatus and method capable of: optimizing limited translation knowledge data in a database mounted in a portable mobile communication terminal such as a smart phone; obtaining translation knowledge data from external servers in order to individually provide translation knowledge data appropriate for each user; and efficiently updating the database mounted in the terminal have been needed. As a related art, Korean Patent Application Publication No. 2013-0025103 exists.

### SUMMARY OF THE INVENTION

Accordingly, in order to improve the problem that translation cannot be accurately performed due to the lack of translation knowledge data resulting from a capacity problem of a mounted automatic interpretation and translation knowledge system, which has been generally distributed, an object of the present invention is to provide an automatic translation apparatus and method which can receive data from external servers for performing translation in response to user input.

Another object of the present invention is to provide an automatic translation apparatus and method which can reduce a user's burden on communication costs in consideration of communication environment conditions with regard to receiving data necessary for performing translation from external servers.

A further object of the present invention is to provide an automatic translation apparatus and method which can receive data necessary for performing translation from external servers, thereby enabling its utilization as data for upgrading a database mounted in the automatic translation apparatus.

In order to accomplish the above objects, the present invention provides an automatic translation apparatus, including: an input unit configured to receive translation target information inputted by a user to be translated; a translation unit configured to perform translation for the translation target information based on translation data included in a translation database and to extract translation information generated during the translation process; and a communication unit configured to transmit the translation information to a first server and to receive, from the first server, new translation data not included in the translation database among various kinds of data necessary for performing the translation of the translation target information.

At this time, the input unit may receive the translation target information in a text or voice form inputted from the user.

At this time, the first server may request a second server for new translation data based on the translation information received from the communication unit and may receive the new translation data from the second server, and the second server may create the new translation data based on data collected from a translation pattern database or a voice recognition database.

At this time, the second server may receive the new translation data from a website of a predetermined translation expert by requesting new translation data from a website when it is judged that it is difficult to create the new translation data based on the data collected from the translation pattern database and the voice recognition database.

At this time, the input unit may enable the user to input information as to whether or not to agree to transmit the translation information to the first server and to receive the new translation data from the first server, and the communication unit may transmit the translation information to the first server and may receive the new translation data from the first server when the user agrees.

At this time, the input unit may enable the user to input information as to whether or not to agree to transmit the new translation data and the translation information to a third server and to construct analysis data for updating the translation database, and the first server may transmit the new translation data and the translation information to the third server when there is the user agrees.

At this time, the input unit may enable the user to input information as to whether or not to agree to transmit the user's personal information included in the translation target information to the first server, and the translation unit may perform preprocessing for excluding the personal information from the translation target information to extract translation information when the user does not agree.

At this time, the translation information may include at least one of analysis data of the translation target information generated during the translation process, a matching record of the translation target information and the translation database, and the details of matching failure of the translation target information and the translation database.

At this time, the automatic translation apparatus may further include a communication condition detecting unit configured to detect a communication environment condition of the communication unit and to control operation of the communication unit.

At this time, the communication condition detecting unit may detect a condition, in which the communication unit can perform communication, in real time, thereby activating the operation of the communication unit on standby when the communication unit is judged to be in the condition in which the communication can be performed, and may detect a cost incurred for performing the communication via the communication unit, thereby activating the operation of the communication unit in standby when it is judged that the cost has a value of less than a predetermined cost.

Also, in order to accomplish the objects, an automatic translation method according to the present invention includes: inputting translation target information from a user to be translated via an input unit of an automatic translation apparatus; performing, based on translation data included in a translation database mounted in the automatic translation apparatus, translation for the translation target information via a translation unit of the automatic translation apparatus, and extracting translation information generated during the translation process; and transmitting the translation information to a first server via a communication unit of the automatic translation apparatus and receiving, from the first server, new translation data not included in the translation database among various kinds of data necessary for performing translation for the translation target information, from the first server.

At this time, the inputting the translation target information may receive the translation target information inputted from the user via text or voice.

At this time, the first server may request a second server for new translation data based on the translation information received in the transmitting the translation information, thereby receiving the new translation data from the second server, and the second server may create the new translation data based on data collected from a translation pattern database or a voice recognition database.

At this time, the second server may request the new translation data from a website of a predetermined translation expert and may receive the new translation data provided from the website when it is judged that it is difficult to create the new translation data based on the data collected from the translation pattern database and the voice recognition database.

At this time, the inputting the translation target information may enable the user to input information as to whether or not to agree to transmit the translation information to the first server and to receive the new translation data from the first server, and the transmitting the translation information may transmit the translation information to the first server and may receive the new translation data from the first server when the user agrees.

At this time, the inputting the translation target information may enable the user to input information as to whether or not agree to transmit the new translation data and the translation information to the third server and to construct analysis data for updating the translation database, and the first server may transmit the new translation data and the translation information to the third server when the user agrees.

At this time, the inputting the translation target information may enable the user to input information as to whether or not to agree to transmit the user's personal information included in the translation target information to the first server, and the performing the translation may extract translation information after performing preprocessing for excluding the personal information from the translation target information when the user does not agree.

At this time, the translation information may include at least one of analysis data of the translation target information generated during the performing the translation, a matching record of the translation target information and the translation database, and the details of matching failure of the translation target information and the translation database.

At this time, the automatic translation method may further include, after the performing the translation, detecting a communication condition for controlling the transmitting the translation information by detecting a communication environment condition via a communication condition detecting unit of the automatic translation apparatus.

At this time, the detecting the communication condition may proceed with the transmitting the translation information when the communication condition is judged to be in a condition in which communication can be performed by detecting such a condition, in which communication can be performed, in real time in the transmitting the translation information, or may proceed with the transmitting the translation information when a cost for communication in the transmitting the translation information is judged to have a value of less than a predetermined cost as a result of detecting the cost.

According to the present invention, data required for performing translation according to the user input can be received from external servers, thereby improving a problem that accurate translation cannot be performed due to the lack of knowledge data caused by a capacity problem of a mounted automatic interpretation and translation knowledge system, which is generally distributed.

Also, according to the present invention, since the data necessary for performing translation is received from external servers, a user's burden on communication costs can be reduced in consideration of communication environment conditions.

Also, according to the present invention, the data for translation received from the external servers can be utilized as data for upgrading a database mounted in the automatic translation apparatus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view for explaining a block diagram of a system for an automatic translation apparatus according to the present invention;

FIG. 2 is a block diagram of the automatic translation apparatus according to the present invention;

FIG. 3 is a flow chart of an automatic translation method according to the present invention;

FIG. 4 is a view for explaining a communication condition detecting unit of the automatic translation apparatus and method according to the present invention; and

FIG. 5 is a view for explaining an embodiment of the automatic translation method according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

Also, terms such as a first term, a second term, A, B, (a), (b) and the like may be used for explaining various constitutive elements. These terms are used only for the purpose for distinguishing a constitutive element from other constitutive element, and an essence, order or the like of the corresponding constitutive elements should not be limited to these terms.

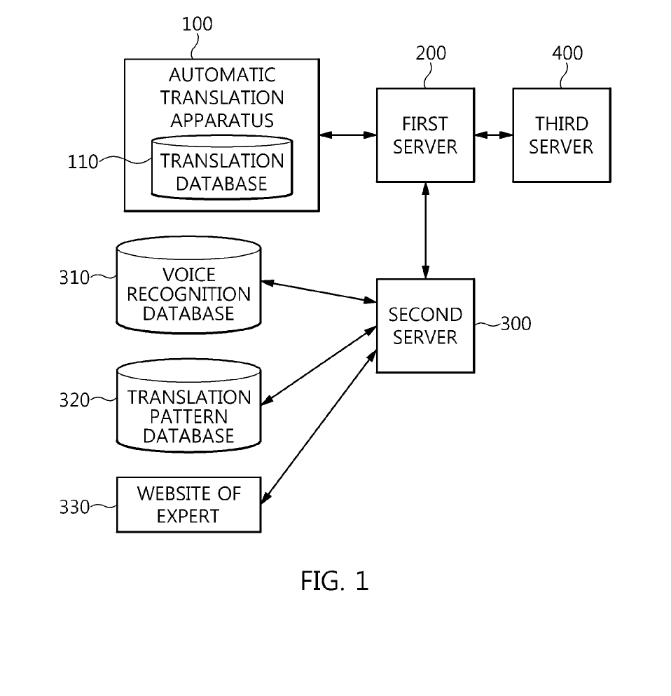

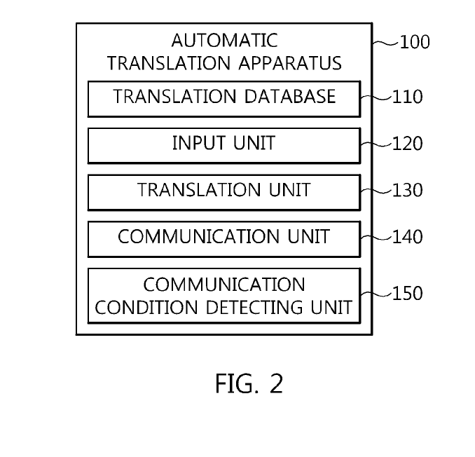

Hereinafter, the configurations and operational principles of a system for an automatic translation apparatus will be described with reference to FIGS. 1 and 2.

FIG. 1 is a view for explaining a block diagram of a system for an automatic translation apparatus according to the present invention. FIG. 2 is a block diagram of the automatic translation apparatus according to the present invention.

Referring to FIGS. 1 and 2, an automatic translation apparatus 100 according to the present invention includes: an input unit 120 configured to receive target information inputted from a user to be translated; a translation unit 130 configured to perform translation for the translation target information based on a translation data included in a translation database 110 mounted in the automatic translation apparatus for translation and to extract translation information generated during the translation process; and a communication unit 140 configured to transmit the translation information to a first server and to receive new translation data not included in the translation database among data necessary for performing the translation for the translation target information from the first server.

Also, the automatic translation apparatus 100 according to the present invention may further include a communication condition detecting unit 150 configured to detect a communication environment condition of the communication unit 140 to control operation of the communication unit 140.

The input unit 120 functions to receive translation target information inputted from a user.

Specifically, the input unit 120 functions to enable inputting translation target information required by the user. Here, the translation target information may refer to a target required by the user to be translated and may be in text form or voice form. That is, the input unit 120 enables the user to input the translation target information via a text or voice.

Also, the input unit 120 may enable the user to input information on various agreements necessary for allowing performing of a specific function of the automatic translation apparatus according to the present invention, and the detailed contents thereon will be described later.

The translation unit 130 functions to perform translation for the translation target information based on the translation data included in the translation database 110 mounted in the automatic translation apparatus for translation and to extract translation information generated during the translation process.

Specifically, the translation database 110 refers to a translation database mounted in the automatic translation apparatus according to the present invention and saves data necessary for performing translation.

Here, since the automatic translation apparatus 100 according to the present invention is generally composed of a small user terminal such as a smart phone and the like, data saved in the translation database 110 may necessarily have a limit in terms of memory size of the respective devices. Accordingly, one feature of the automatic translation apparatus 100 according to the present invention is that data is provided from external servers via the communication unit 140 to be described later.

The translation information may include at least one of analysis data of the translation target information generated during the translation process performed via the translation unit 130, a matching record of the translation target information and the translation database 110, and the details of matching failure.

Specifically, the translation information refers to intermediate information such as analysis failure information and conversion pattern matching information generated during the process of performing the translation based on the translation database 110.

Here, the analysis data of the translation target information refers to data in which a sentence inputted for translation is divided into a subject, an object, a noun, an adjective and the like according to each constituent.

Also, the matching record of the translation target information and the translation database 110 refers to a record resulting from matching the translation target information inputted by the user for translation with the data being present in the translation database 110 mounted in the automatic translation apparatus 100, and the details of matching failure of the translation target information and the translation database 110 refer to the details resulting from translation failure caused by a case in which no data matched with the translation target information inputted by the user for translation is present in the translation database 110 mounted in the automatic translation apparatus 100.

Also, the translation information may include a result finally selected by the user or a result in which factors of performing a TTS (Text to Speech) task are detected when a plurality of translation results in a target language exists during performing the translation via the translation unit 130.

Also, the translation information may include clear user feedback information such as the user's grade on the translation performed via the translation unit 130.

Also, the translation information may include translation target information and translation result information.

Accordingly, the translation information includes various contents on the translation progress process based on the translation database mounted in the automatic translation apparatus 100.

The communication unit 140 functions to transmit the translation information to a first server 200 and to receive new translation data, which is translation data not included in the translation database 110 among data necessary for performing translation for the translation target information, from the first server 200.

At this time, the input unit 120 enables the user to input information as to whether or not he or she agrees to transmit the translation information to the first server 200 and to receive the new translation data from the first server 200, and the communication unit transmits the translation information to the first server and receives the new translation data from the first server when the user agrees.

That is, since the user may not want to publish his or her translation information to the outside and also may not want translation performed using an external server, the user's intention is determined via the input unit, and the process for transmitting the translation information to the first server 200 is performed only when the user agrees.

Also, the first server requests a second server 300 for the new translation data based on the translation information received from the communication unit 140 and receives the new translation data from the second server 300, and the second server 300 may create the new translation data based on data collected from a translation pattern database 320 or a voice recognition database 310.

At this time, the first server 200 which receives the new translation data from the second server 300 may carry out a push notification via the communication unit 140. Accordingly, based on the push notification, the user may recognize that the translation database 110 reaches a condition which can be updated.

Here, the translation pattern database 320 and the voice recognition database 310 refer to external databases which are not mounted in the automatic translation apparatus 100 according to the present invention, and include richer data than that of the translation database 110 mounted in the automatic translation apparatus according to the present invention. Accordingly, even though there is a part which cannot be translated based on the translation database 110, accurate translation may be performed when the translation pattern database 320 and the voice recognition database 310 are used.

Also, the new translation data refers to data generated from the second server 300 via the first server 200, namely, data which is not included in the translation database 110, because translation for the translation target information cannot be performed based on only the translation data included in the translation database 110 mounted in the automatic translation apparatus in order to perform the translation via the translation unit 130.

Specifically, the translation pattern database 320 is utilized when the user desires that a text is translated by inputting the text in the input unit 120, and the voice recognition database 310 is utilized when the user desires that voice information is translated by inputting his or her voice in the input unit 120.

Also, when it is judged that it is difficult to create new translation data based on the data collected from the translation pattern database 320 and the voice recognition database 310, the second server 300 may request new translation data from a website 330 of a predetermined translation expert, thereby receiving the new translation data from the website 330.

That is, in a case where it is judged that it is difficult to translate the translation target information required to be translated by the user even though the translation pattern database 320 and the voice recognition database 310 are used, a request for translation is transmitted to an address of the website 330 of the predetermined translation expert and interpretation expert via the communication unit 140. Here, the request for translation includes receiving new translation data for translation despite the fact that the translation may be directly performed.

Accordingly, the second server 300, which receives the new translation data from the address of the website of the predetermined translation expert and interpretation expert, transmits the new translation data to the first server 100, and the first server 110 transmits the received new translation data to the automatic translation apparatus 100 according to the present invention, thereby enabling accurate translation to be performed by the automatic translation apparatus 100.

At this time, by adding the new translation data to the translation database 110 mounted in the automatic translation apparatus 100, the translation database 110 is updated.

Also, the input unit 120 enables the user to input information as to whether or not to agree to construct analysis data for updating the translation database 110 by transmitting the new translation data and the translation information to a third server, and in a case where the user agrees, the first server 200 may transmit the new translation data and the translation information to a third server 400.

Specifically, in order to update the translation database 110 mounted in the automatic translation apparatus 100 according to the present invention, information is needed, and this information becomes the new translation data and the translation information possessed by the first server 200.

However, since the translation data and the translation information correspond to information generated from the user, the user's agreement must be obtained for their utilization.

Accordingly, only when the user agrees via the input unit 120, the new translation data and the translation information are transmitted to the third server so as to be utilized as data for updating the translation database.

For example, if a version of the translation database mounted in the automatic translation apparatus 100 according to the present invention is a first version, the new translation data and the translation information can be utilized as data for creating a second version which is a next version of the translation database. That is, the new translation data and the translation information are provided to a manufacturer or a supplier of the automatic translation apparatus 100 as data for manufacturing the next version of the translation database.

At this time, when the user agrees, a fixed advantage (a coupon, a mileage point or the like) may be provided to the user in terms of a policy and marketing.

Of course, since the new translation data and the translation information are present in the automatic translation apparatus 100 of the user, the translation database can be updated in a further improved form than that of the translation database in the first version.

Also, the input unit 120 may enable the user to input information as to whether or not to agree to transmit his or her personal information included in the translation target information to the first server 200, and when the user disagrees with it, the translation unit 130 may extract translation information after carrying out preprocessing for excluding the personal information from the translation target information.

Specifically, the user's personal information may be included in the translation target information required to be translated.

In other words, the user's personal information included in the translation target information required to be translated may be deemed to be a sensitive proper noun or non-registered vocabulary.

For example, the user's resident registration number, address, name or the like may be included in a sentence to be translated.

At this time, in a case where translation for the translation target information is performed in a state when the user's resident registration number, address or the like is included in the translation target information, and translation information created during the translation process is transmitted to the third server, it may lead to disclosure of the user's personal information. Due to this, the user's agreement being given, preprocessing for excluding the user's personal information from the translation target information is performed when the user does not desire leakage of his or her personal information.

Accordingly, even though translation is performed, since the user's personal information is excluded from the translation, and the translation information is also created with the user's personal information being excluded, and thus the user's personal information is prevented from being leaked.

The automatic translation apparatus 100 according to the present invention may further include a communication condition detecting unit 150 intended for controlling operation of the communication unit 140 by detecting a communication environment condition of the communication unit 140.

At this time, the communication condition detecting unit 150 may activate the operation of the communication unit 140 in standby when judging that the communication unit 140 is in a condition capable of performing communication by detecting the condition in which communication of the communication unit 140 can be performed.

That is, when the communication unit 140 is judged to be in a condition in which communication cannot be performed, the communication condition detecting unit 150 controls the operation of the communication unit in an inactive state and puts the operation of the communication unit on hold. Then, when the communication unit 140 is judged to be in a condition (e.g., an Wi-fi zone) in which communication can be performed, the communication condition detecting unit 150 may control the communication unit 140 to be operated by activating the communication unit 140 on standby.

Also, the communication condition detecting unit 150 may activate the operation of the communication unit 140 on standby when as a result of detecting a communication cost incurred for communication of the communication unit 140, the cost is judged to have a value which is less than a predetermine cost.

Specifically, the communication condition detecting unit 150 may detect a communication environment condition in which a relatively low cost is incurred, such as a non-roaming environment, Wi-fi access or the like.

That is, by calculating the cost incurred for transmitting the translation information to the first server via the communication unit 140 or receiving new translation data from the first server, when the cost is higher than a predetermined cost, the communication unit 140 is controlled in a standby state, and when the calculated cost is lower than the predetermined cost, the communication unit 140 is controlled in an activation state, so that the communication unit 140 can be controlled to be operated.

At this time, regardless of a corresponding communication environment condition, based on direct expression of the user's agreement, the communication unit may be designed so as to unconditionally transmit or receive information in a condition in which communication can be performed.

Hereinafter, the operation of the automatic translation apparatus 100 according to the present invention will be described in detail based on the detailed cases.

It is assumed that the user inputted the following Korean language in the input unit 110: “He blocked the car with his body.”

At this time, when translation is performed via the translation database 110 mounted in the automatic translation apparatus 100, the following translation processes (before and after the translation) are performed.

1. Before the translation: (noun: subject) (noun [meaning=artificial place]: object+something) block/verb, 2. After the translation: (noun:subject) [symbol] verb (noun:object)

Here, the car accurately mentioned in the original text refers to a car rather than referring to a specific place, and at this time, the Chinese verb of the verb “block” may have the following target words which are different from the word which is actually required.

1. Block: [symbol] (X)

2. Block: [symbol] (O)

Even though the translation is performed by the pattern, a mistranslation is generated, and in this process, matched information and original text information are possessed. That is, the translation information includes the matched information and the original text information (the translation target information).

The translation information is saved in the automatic translation apparatus 100, and when the communication condition detecting unit 150 detects a communication condition in which the communication unit 140 may perform communication or a communication condition in which communication may be performed at a low expense by using an Wi-fi zone and the like, the user may be questioned about his or her intention on information transmission. At this time, when the user agrees to transmit the information, the communication unit 140 of the automatic translation apparatus 100 transmits the translation information to the first server 200.

According to another embodiment, with regard to the intention on information transmission as described above, when a Wi-fi zone and the like are automatically detected by the user's configuration, data may be transmitted to the first server 200 without any question. When the transmission of the translation information is completed, collected information may be set to be automatically removed from the automatic translation apparatus 100 in order to reduce the amount used of the translation database mounted in the automatic translation apparatus 100 according to the present invention.

Hereinafter, the translation information in an XML form will be described based on the above example.

The translation information may be the following.

<Original text>He blocked the car with his body.</original text>

<Analysis information>

<morpheme analysis information>He/pronoun+anyone body/noun+with car/noun+something block/verb+−ed/suffix for the past tense+being/final ending</morpheme analysis information>

<Structure analysis information>(being omitted)</Structure analysis information>

</analysis information>

<Conversion information>

<Translation pattern matching information>(noun:subject) ((noun [meaning=artificial place]:object+something) block/verb. ->(noun:subject) [symbol] /verb (noun: object)</translation pattern matching information>

</Conversion information>

When the first server 200 receives the translation information transmitted from the communication unit 140, the first server 200 again transmits the translation information to the second server 300, thereby investigating whether or not non-processed data omitted from the translation database 110 mounted in the automatic translation apparatus 100 is present in the voice recognition database 310, the translation pattern database 320 and the website 330 of the expert.

The voice recognition database 310 and the translation pattern database 320 may include translation data required by the user by detecting appropriate domains. When translation data being of help to the improvement of translation quality or voice recognition ability is found, the second server creates new translation data. During this process, data transmitted from the website 330 of the expert may be additionally constructed.

By continuously utilizing the above examples, the second server may investigate or construct new knowledge data as follows.

<Conversion knowledge data_{—}1>(noun:subject) (noun[meaning=car]:object) block/verb ->(noun:subject) [symbol] /verb (noun:object)</conversion knowledge data_{—}1>

<Conversion knowledge data_{—}2>(noun[meaning=car]: subject) (accident/noun: subject)generate/verb ->(noun: subject) [symbol] (Chinese character of the verb ‘generate’)/verb ( [symbol] (in Chinese character of the noun ‘accident’)/noun:object)</conversion knowledge data_{—}2>

At this time, when there is the collection of grouped patterns resulting from utilizing the transmitted translation information, it may be similarly used, but as “conversion knowledge 2” exemplified above, various kinds of knowledge data which are not present in the translation database 110 in the automatic translation apparatus 100 being currently used by the user are collected so that the user can obtain another translation result related to the corresponding text (translation target information) in better quality.

At this time, when new translation data is generated from the second server 300, the second server 300 transmits a signal of completion to the first server 100, and the first server 200 which receives the new translation data from the second server 300 may perform a push notification via the communication unit 140. Accordingly, through the push notification, the user may recognize that the translation database 110 has reached a state in which it can be updated.

That is, the user confirms that new knowledge database can be utilized, and when the automatic translation apparatus 100 according to the present invention downloads the corresponding knowledge database (new translation data), the automatic translation apparatus utilizes the translation database 110 mounted in the automatic translation apparatus 100 in the translation process by adding the new translation data, thereby enabling providing of interpretation and translation services in better quality.

Hereinafter, an automatic translation method according to the present invention will be described. The description of the same technical contents as those of the automatic translation apparatus 100 according to the present invention reviewed above is omitted.

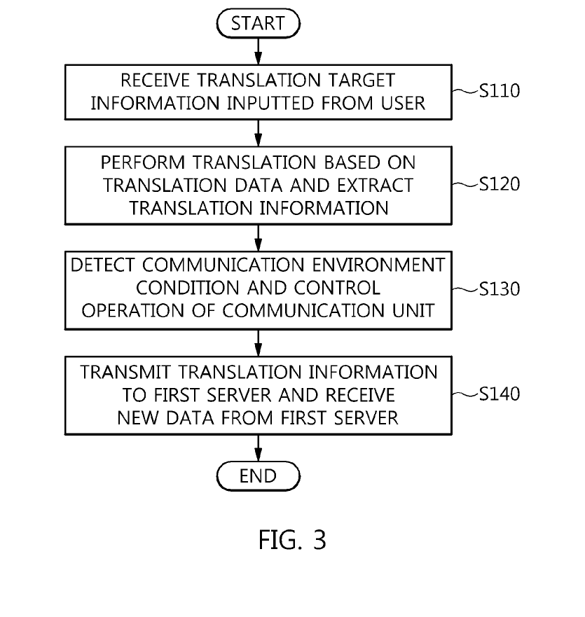

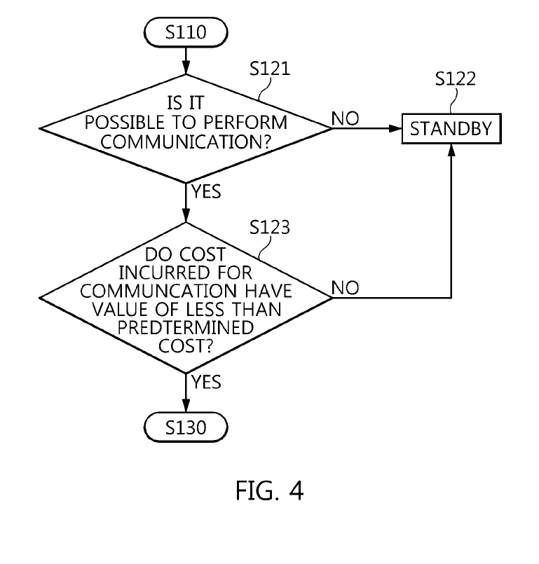

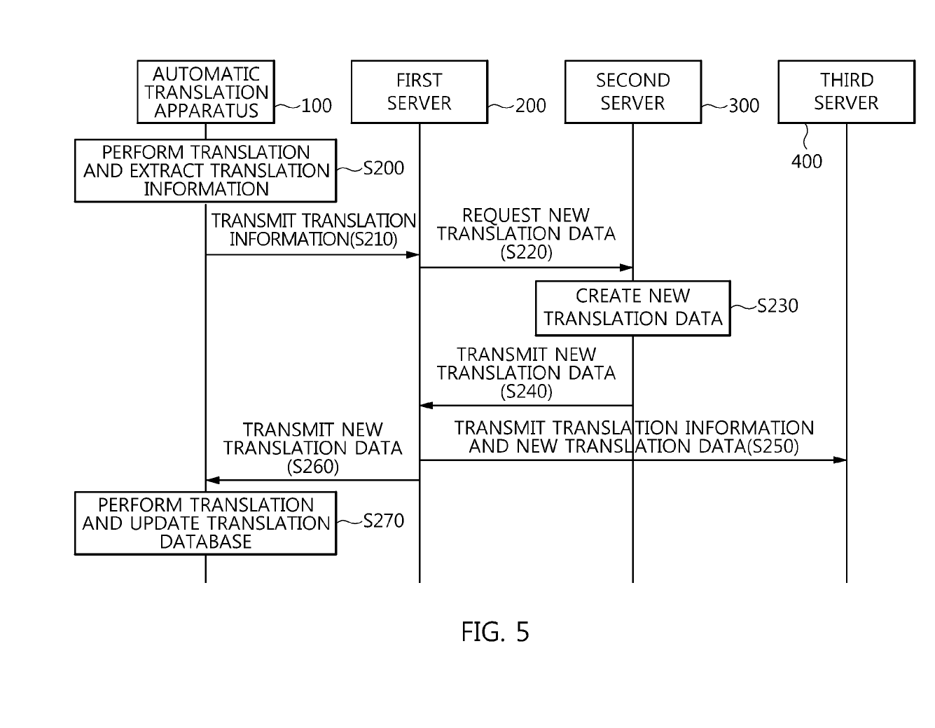

FIG. 3 is a flow chart of the automatic translation method according to the present invention. FIG. 4 is a view for explaining a communication condition detecting unit of the automatic translation apparatus and method according to the present invention. FIG. 5 is a view for explaining an embodiment of the automatic translation method according to the present invention.

Referring to FIG. 3, the automatic translation method according to the present invention includes: inputting translation target information from a user to be translated via an input unit of an automatic translation apparatus (S110); performing, based on translation data included in a translation database mounted in the automatic translation apparatus, translation for the translation target information via a translation unit of the automatic translation apparatus, and extracting translation information generated during the translation process (S110); detecting a communication condition for controlling a communication stage by detecting a communication environment condition via a communication condition detecting unit of the automatic translation apparatus (S120); and transmitting the translation information to a first server via a communication unit of the automatic translation apparatus and receiving new translation data, which is not included in the translation database among various kinds of data necessary for performing translation for the translation target information, from the first server (S130).

Explaining one embodiment of the automatic translation method according to the present invention with reference to FIG. 4, after performing step S110 above, a step of judging as to whether or not it is possible to perform communication (S121) is carried out. At this time, in Step S121 above, when the communication condition is judged to be in a condition in which communication cannot be performed, Step S122 is carried out, thereby leading to a standby state. That is, the communication step (S130) is not carried out, thereby leading to the standby state. On the contrary, in step S121 above, when it is judged that it is possible to perform communication, step S123 is carried out, and thus whether or not a cost for performing communication has a value of less than a predetermined cost is determined. That is, this step is intended to perform the communication step only when the cost resulting from calculating the cost required for performing the communication step (S130) in a current network environment is less than the predetermined cost.

When the cost incurred for the communication in step S123 above is judged to have a value of less than the predetermined cost, the communication step (S130) is performed, and when the cost is judged not to have a value of less than the predetermined cost, step S122 above is performed, thereby leading to a standby state.

Explaining information exchange among the automatic translation apparatus 100, the first server 200, the second server 300 and the third server 400 with reference to FIG. 5, translation is performed and translation information is extracted via the automatic translation apparatus 100 according to the present invention (S200). The translation performed in step S200 above is realized by utilizing the translation database mounted in the automatic translation apparatus 100. Then, the extracted translation information is transmitted to the first server 200 (S210). The fact that the user's agreement can be obtained prior to performing step S210 above has been previously described.

After step S210 above, the first server 200 requests the second server 300 for new translation data (S220), and the second server 300 requested with the new translation data creates the new translation data (S230). As previously reviewed, in order to create the new translation data, the voice recognition database (310), the translation pattern database (320) and the website 330 of the expert may be utilized.

After step S230 above, the second server 300 transmits the new translation data to the first server 200 (S240).

Then, the first server 200 transmits the translation information received from the automatic translation apparatus 100 and the new translation data received from the second server 300 to the third server 400 on the premise that the user agrees (S250).

The third server 400 may utilize the translation information and the new translation date received from the second sever 300 as data for updating the translation database 110 mounted in the automatic translation apparatus 100 into the next version.

After step S250 above, the first server 200, which receives the new translation data transmitted from the second server 300, transmits the new translation data to the automatic translation apparatus 100 (S260). The automatic translation apparatus 100 receiving the new translation data carries out updating work for adding the new translation data to the translation database, thereby performing an accurate translation by utilizing the translation database to which the new translation data is added.

As reviewed above, according to the automatic translation apparatus 100 and method of the present invention, data required for performing translation according to the user's input can be received from external servers, thereby improving a problem that accurate translation cannot be performed due to the lack of knowledge data caused by a capacity problem of a mounted automatic interpretation and translation knowledge system, which is generally distributed.

Also, it is advantageous in that since the data required for performing the translation is provided from external servers, the user's communication costs can be reduced in consideration of a communication environment condition, and the data received from the external servers can be utilized as data for upgrading a database mounted in the automatic translation apparatus.

As described above, the automatic translation apparatus and method according to the present invention should not be limited to the configurations and methods of the embodiments as described above. All or a part of the embodiments may be selectively combined and configured so as to have various modifications.

What is claimed is:

1. An apparatus for automatic translation, comprising:
an input unit configured to receive translation target information inputted by a user to be translated;
a translation unit configured to perform translation of the translation target information based on translation data included in a translation database and to extract translation information generated during the translation process; and
a communication unit configured to transmit the translation information to a first server and to receive, from the first server, new translation data not included in the translation database among various kinds of data necessary for performing the translation for the translation target information.

2. The apparatus as set forth in claim 1, wherein the input unit receives the translation target information in a text or voice form inputted from the user.

3. The apparatus as set forth in claim 2, wherein the first server requests a second server for new translation data based on the translation information received from the communication unit and receives the new translation data from the second server, and the second server creates the new translation data based on data collected from a translation pattern database or a voice recognition database.

4. The apparatus as set forth in claim 3, wherein the second server receives the new translation data from a website of a predetermined translation expert by requesting the new translation data from the website when it is judged that it is difficult to create the new translation data based on the data collected from the translation pattern database and the voice recognition database.

5. The apparatus as set forth in claim 3, wherein the input unit enables the user to input information as to whether or not to agree to transmit the translation information to the first server and to receive the new translation data from the first server, and the communication unit transmits the translation information to the first server and receives the new translation data from the first server when the user agrees.

6. The apparatus as set forth in claim 5, wherein the input unit enables the user to input information as to whether or not to agree to transmit the new translation data and the translation information to a third server and to construct analysis data for updating the translation database, and the first server transmits the new translation data and the translation information to the third server when the user agrees.

7. The apparatus as set forth in claim 1, wherein the input unit enables the user to input information as to whether or not to agree to transmit the user's personal information included in the translation target information to the first server, and the translation unit performs preprocessing for excluding the personal information from the translation target information and extracts the translation information when the user does not agree.

8. The apparatus as set forth in claim 1, wherein the translation information comprises at least one of analysis data of the translation target information generated during the translation process, a matching record of the translation target information and the translation database, and the details of matching failure of the translation target information and the translation database.

9. The apparatus as set forth in claim 1, further comprising a communication condition detecting unit configured to detect a communication environment condition of the communication unit and to control operation of the communication unit.

10. The apparatus as set forth in claim 9, wherein the communication condition detecting unit detects a condition, in which the communication unit can perform communication, in real time, thereby activating the operation of the communication unit on standby when the communication unit is judged to be in the condition in which the communication can be performed, or detects a cost incurred for performing the communication by the communication unit, thereby activating the operation of the communication unit on standby when the cost is judged to have a value of less than a predetermined cost.

11. A method for automatic translation, comprising:
inputting translation target information from a user to be translated via an input unit of an automatic translation apparatus;
performing, based on translation data included in a translation database mounted in the automatic translation apparatus, translation for the translation target information via a translation unit of the automatic translation apparatus, and extracting translation information generated during the translation process; and
transmitting the translation information to a first server via a communication unit of the automatic translation apparatus and receiving new translation data, which is not included in the translation database among various kinds of data necessary for performing translation for the translation target information, from the first server.

12. The method as set forth in claim 11, wherein the inputting the translation target information receives the translation target information inputted from the user via text or voice.

13. The method as set forth in claim 12, wherein the first server requests a second server for new translation data based on the translation information received in the transmitting the translation information, thereby receiving the new translation data from the second server, and the second server creates the new translation data based on data collected from a translation pattern database or a voice recognition database.

14. The method as set forth in claim 13, wherein the second server requests the new translation data from a website of a predetermined translation expert and receives the new translation data provided from the website when it is judged that it is difficult to create the new translation data based on the data collected from the translation pattern database and the voice recognition database.

15. The method as set forth in claim 13, wherein the inputting the translation target information enables the user to input information as to whether or not to agree to transmit the translation information to the first server and to receive the new translation data from the first server, and the transmitting the translation information transmits the translation information to the first server and receives the new translation data from the first server when the user agrees.

16. The method as set forth in claim 15, wherein the inputting the translation target information enables the user to input information as to whether or not agree to transmit the new translation data and the translation information to a third server and to construct analysis data for updating the translation database, and the first server transmits the new translation data and the translation information to the third server when the user agrees.

17. The method as set forth in claim 11, wherein the inputting the translation target information enables the user to input information as to whether or not to agree to transmit his or her personal information included in the translation target information to the first server, and the performing the translation extracts translation information after performing preprocessing for excluding the personal information from the translation target information when the user does not agree.

18. The method as set forth in claim 11, wherein the translation information comprises at least one of analysis data of the translation target information generated during the performing the translation, a matching record of the translation target information and the translation database, and the details of matching failure of the translation target information and the translation database.

19. The method as set forth in claim 11, further comprising, after the performing the translation, detecting a communication condition for controlling the transmitting the translation information by detecting a communication environment condition via a communication condition detecting unit of the automatic translation apparatus.

20. The method as set forth in claim 19, wherein the detecting the communication condition proceeds with the transmitting the translation information when the communication condition is judged to be in a condition in which communication can be performed by detecting such a condition, in which communication can be performed, in real time in the transmitting the translation information, or proceeds with the transmitting the translation information when a cost incurred for communication in the transmitting the translation information is judged to have a value of less than a predetermined cost as a result of detecting the cost.
